(19) United States
(12) Patent Application Publication
(10) Pub. No.: US 2020/0299454 A1
(43) Pub. Date: Sep. 24, 2020

(54) IMIDE-CONTAINING POLYESTER

(71) Applicant: Covestro Deutschland AG, Leverkusen (DE)

(72) Inventors: Michael Schedler, Leverkusen (DE); Hartmut Nefzger, Pulheim (DE); Niklas Meine, Düsseldorf (DE); Gernot Jaeger, Köln (DE); Torsten Hagen, (DE); Michael Baecker, Korschenbroich (DE); Peter Nordmann, Dormagen (DE)

(21) Appl. No.: 16/761,581

(22) PCT Filed: Nov. 27, 2018
(86) PCT No.: PCT/EP2018/082714

§ 371 Date: May 5, 2020

(30) Foreign Application Priority Data
Nov. 29, 2017 (EP) 17204379.6

(51) Int. Cl. C08G 18/60; C08G 63/685; C08J 9/14

(52) U.S. Cl. CPC C08G 18/606; C08G 2101/0025; C08J 9/141; C08G 63/6856

(57) ABSTRACT

The present invention relates to a special process for preparing polyesterols having terminal hydroxyl groups and containing imide groups, to the polyesters per se, and to their use for the preparation of polyurethanes.

The present invention relates to a specific process for preparing hydroxyl group-terminated, imide group-containing polyesterols, to these polyesters themselves, and also to the use thereof for the preparation of polyurethanes.

U.S. Pat. No. 3,217,014 B1 and the publication “Synthesis and Properties of Polyesterimides and their Isomers”, Sukumar Maiti and Sajal Das, Journal of Applied Polymer Science, vol. 26, 957-978 (1981), Wiley & Sons, Inc. describe a synthesis of hydroxyl group-terminated, imide group-containing polyesterols. To this end, firstly trimellitic acid or hemimellitic acid, or the anhydride thereof, is condensed with p-, o- or m-aminobenzoic acid to give an aromatic, imide group-containing dicarboxylic acid and this is then esterified with an alcohol. In both cases, large amounts of solvents such as DMF are used to prepare the imide group-containing dicarboxylic acid. This necessitates a very complicated purification step in which the solvent is removed, before the dicarboxylic acid can be supplied to the esterification.

The hydroxyl group-terminated, imide group-containing polyesterols described in the documents have high melting points above 250° C., as a result of which they are unsuitable for use as a reaction partner for isocyanates in polyurethane preparation.

FR 1445078 A and DE 2023456 A1 also describe hydroxyl group-terminated, imide group-containing polyesterols as enamels for wires. For this purpose, amino alcohols, aminocarboxylic acids or diamines are reacted with carboxylic anhydrides, with both applications obtaining at least bifunctional polyols. This is by the use of at least trifunctional carboxylic acids or the anhydrides thereof (especially trimellitic anhydride (3-functional) or pyromellitic dianhydride (4-functional). The use of these polyfunctional carboxylic acids results in the polyols formed having a high viscosity and therefore being able to be processed only after dissolution in a suitable solvent.

It was an object of the present invention to provide a much simpler and hence more economical process for preparing hydroxyl group-terminated, imide group-containing polyesterols than is known from the prior art. The polyesterols should in addition be suitable for use in polyurethane foam production. The use of polyesterols in solvents for the preparation of polyurethane foams is not expedient in technical or economic terms, and as a result it was an object to prepare imide-containing polyesterols which have a lower viscosity so that said polyesterols can be processed further without solvent. A third aspect was moreover the use of bio-based raw materials as a cost-effective and sustainable alternative to the raw materials obtainable industrially. This object was achieved in accordance with the invention by a process for preparing hydroxyl group-terminated polyesterols (A), characterized in that,
in a first process step, imide group-containing mono- or polycarboxylic acids (B) are first prepared by reacting
   (B.1) at least one amino acid having one or more amino groups and one or more acid groups with
   (B.2) at least one carboxylic anhydride having precisely one anhydride group and no further free acid groups
   in the presence of
   (C) at least one diol and/or polyol having a molecular weight of 62 to 1000 g/mol,
and, in a second process step, the reaction mixture obtained in the first process step is esterified
   without purification,
   optionally with addition of further component B.2 and/or further component C and/or (D) further mono- and/or polycarboxylic acids which do not fall under the definition of components (B) and (B.2),
under polycondensation conditions,
wherein auxiliaries and additives (E) are optionally used in the first process step and/or in the second process step and wherein no further solvent besides component (C) is added in the first process step.

As a result of the use of amino acids and merely difunctional carboxylic anhydrides having precisely one precisely one anhydride group and no further acid group, which results in imide-containing polyester polyols being obtained which are prepared in a solvent-free, and thus particularly economically expedient, one-pot process, and by means of the avoidance of tri- or polyfunctional carboxylic anhydrides, as a result of which a lower functionality and viscosity can be achieved than those described in the prior art. Surprisingly, it appears that these lower-functionality polyols can be processed further without solvent and hence are very well suited to the production of polyurethane foams.

In the second process step, the same or different compounds may be used for component B.2/component C as/than in the first process step.

In the present process, component (C) serves initially, that is to say in the first process step, as a solvent for components (B.1) and (B.2), meaning that no further solvent needs to be added. In a preferred embodiment, at the most an amount of further solvents which is of a volume less than the total volume of components (B.1), (B.2) and (C) is added in addition to component (C) in the first process step. In the process according to the invention, no further solvents besides component (C) are added in the first process step. “Further solvents” that are optionally to be used and are mentioned merely by way of example include aliphatic and aromatic hydrocarbons (e.g. benzines, toluene), monoalcohols (ethanol), ethers (THF), esters (ethyl acetate), ketones (acetone), halohydrocarbons (methylene chloride), nitrogen compounds and sulfur compounds (DMF, DMSO).

In the second process step, component (C) serves as condensation partner for component (B) and any component (D) added.

Since no further solvent besides component (C) needs to be added in the first process step, the advantage of the inventive process over the prior art accordingly resides in the fact that the product from the first process step does not need to be purified, that is to say does not need to be freed of added solvent, before it is supplied to the esterification. The synthesis can thus be conducted as a one pot-synthesis.

The present invention also provides a process as described above, wherein, for the preparation of the hydroxyl group-terminated polyesterols (A), in addition to components (B.1), (B.2), (C), (D) and (E) a further component (F) is used and the proportion of components (B.1), (B.2), (C), (D) and (E) is ≥80, preferably ≥90, particularly preferably ≥95 percent by weight of the total amount of all components used. Component (F) comprises diols and polyols which do not fall under the definition of component (C).

Preference is given to the process variant described first, in which exclusively components (B.1), (B.2), (C), (D) and (E) are used and not (F).

The first process step is preferably conducted at temperatures of 25° C. to 200° C., particularly preferably of 80 to 180° C. The second process step is conducted under polycondensation conditions; within the context of the present invention this means at temperatures of preferably 150 to 250° C., particularly preferably of 180 to 220° C. and at reduced pressure in the range from preferably 0.1 to 300 mbar, particularly preferably 1 to 200 mbar.

Preference is given, in the first process step, to initially charging amino acids, carboxylic anhydrides and diols/polyols together in an apparatus and heating them at standard pressure while stirring. Particular preference is given here to a mode of operation which permits a reaction of the amino acids with the carboxylic anhydrides to give imides without having previously carried out an esterification between carboxylic acid groups and diol/polyol. This can be determined via determination of the amine number, acid number and OH number of the reaction mixture. In the first process step, water which formed previously can also be distilled off via a column. This is not understood to be purification within the context of the invention.

In the second process step, the reaction mixture, preferably without addition of further substances, is heated to such an extent that esterification takes place and water of reaction is distilled off via a column. Preference is given here to a mode of operation in which a major part of the water being released is eliminated under standard pressure and subsequently, possibly after addition of an esterification catalyst, the remaining water of reaction is distilled off under reduced pressure. Preference is given to a process that, after elimination of the expected amount of water, affords a product having an acid number of <3 mg KOH/g, particularly preferably <1 mg KOH/g, and an amine number of <3 mg KOH/g, particularly preferably <1 mg KOH/g and the desired OH number. The desired OH number can optionally be adjusted by addition of further diols/polyols, followed by an equilibration of the mixture under reduced pressure at 150-250° C.

The present invention further provides hydroxyl group-terminated polyesterols (A) which are obtainable by the process as described above and which preferably have a melting point of <23° C., particularly preferably ≤20° C.

The present invention further provides hydroxyl group-terminated polyesterols (A) which are obtainable from
(B) imide group-containing mono- or polycarboxylic acids,
   which are obtainable by solvent-free reaction of
   (B.1) at least one amino acid having one or more amino groups and one or more acid groups with
   (B.2) at least one carboxylic anhydride having precisely one anhydride group and no further free acid groups,
(C) at least one diol and/or polyol having a molecular weight of 62 to 1000 g/mol,
(D) optionally further mono- and/or polycarboxylic acids which do not fall under the definition of components (B) and (B.2),
(E) optionally auxiliaries and additives
and optionally further component (B.2), and also optionally further component (C),

and preferably have a melting point of <23° C., particularly preferably ≤20° C.

The present invention likewise provides hydroxyl group-terminated polyesterols (A) as described above, wherein for the preparation thereof, however, in addition to components (B.1), (B.2), (C), (D) and (E) a further component (F) is used and the proportion of components (B.1), (B.2), (C), (D) and (E) is ≥80, preferably ≥90, particularly preferably ≥95 percent by weight of the total amount of all components used. Component F comprises diols and polyols which do not fall under the definition of component C.

Preference is given to hydroxyl group-terminated polyesterols (A) prepared exclusively using components (B.1), (B.2), (C), (D) and (E).

The hydroxyl group-terminated polyesterols (A) according to the invention preferably have OH numbers of 20 to 500 mg KOH/g, particularly preferably of 35 to 350 mg KOH/g, number-average functionalities of 1.4 to 3.5, preferably of 1.5 to 2.6. In addition, the polyesterols according to the invention are homogeneous liquids without solids content, the color of which may vary from colorless to brown. The polyesterols (A) according to the invention preferably have a viscosity at 25° C. of <20 000 mPa*s, particularly preferably <5000 mPa*s at 25° C.

The polyesterols (A) according to the invention have melting points of <23° C., preferably ≤20° C., so that it is not possible for crystals to form on storage at room temperature (23° C.).

Description of the Components:

Component (B):

Component (B) is imide group-containing mono- and polycarboxylic acids.

Component (B) is prepared by reacting component (B.1) with component (B.2).

In this case, the amounts of amino acids and carboxylic anhydrides is selected such that the molar ratio of amino groups from the amino acids (B.1) to anhydride groups from the carboxylic anhydrides (B.2) is in the range from 1.5:1 to 1:1.5, preferably 0.9:1 to 1:0.9, particularly preferably 0.95:1 to 1:0.95.

Component (B.1):

Component (B.1) comprises amino acids having one or more amino groups and one or more acid groups.

These include for example saturated or unsaturated, linear or branched, aliphatic or cycloaliphatic amino acids or optionally branched aromatic amino acids, having preferably up to 20, particularly preferably up to 10 carbon atoms (including the carbon atoms of the carboxylic acid groups), which may optionally include heteroatoms from the group of oxygen (ignoring the oxygen atoms of the free acid groups), sulfur, nitrogen (ignoring the nitrogen atoms of the amino groups) and halogens. The amino acids preferably have up to 2 amino groups and up to 2 acid groups.

Examples include the following amino acids:

anthranilic acid (o-aminobenzoic acid), m-aminobenzoic acid, p-aminobenzoic acid, alanine, arginine, asparagine, aspartic acid, cysteine, glutamine, glutamic acid, glycine, histidine, isoleucine, leucine, lysine, methionine, phenylalanine, serine, threonine, tryptophan, tyrosine, valine, ornithine, 3-aminopropionic acid, 2-aminobutyric acid, 4-aminobutyric acid, 6-aminocaproic acid, 2-amino-2-methylpropionic acid, 11-aminoundecanoic acid, homoserine.

Preference is given to the amino acids (B.1) selected from the group consisting of o-, m-, or p-aminobenzoic acid, glutamic acid, aspartic acid or lysine.

The amino acids may be used individually or in a mixture in the process according to the invention.

Component (B.2):

Component (B.2) comprises carboxylic anhydrides having precisely one anhydride group and no further free acid groups.

These include for example saturated or unsaturated, linear or branched, aliphatic or cycloaliphatic carboxylic anhydrides or optionally branched aromatic carboxylic anhydrides having preferably up to 20, particularly preferably up to 10 carbon atoms (including the carbon atoms of the anhydride groups and free carboxylic acid groups), which optionally include heteroatoms from the group of oxygen (ignoring the oxygen atoms of the anhydride groups or of the free acid groups), sulfur, nitrogen and halogens.

Examples include the following carboxylic anhydrides:

phthalic anhydride, tetrachlorophthalic anhydride, 3-chlorophthalic anhydride, maleic anhydride, citraconic anhydride, itaconic anhydride, succinic anhydride, 1,8-naphthalic anhydride, derivatives of the anhydrides mentioned, such as for example alkyl- or alkenylsuccinic acids having unbranched or branched C1 to C24 alkyl or alkenyl chains, such as (1-dodecen-1-yl) or 2-dodecen-1-yl)succinic anhydride, n-octenylsuccinic anhydride, tetradecenylsuccinic anhydride, hexadecenylsuccinic anhydride, octadecenylsuccinic anhydride, alkyl- and/or alkenylmaleic acids having unbranched or branched C1 to C24 alkyl or alkenyl chains, such as dimethylmaleic anhydride, n-dodecenylmaleic anhydride, and Diels-Alder adducts of furans and for example maleic anhydride.

Preferably, the carboxylic anhydride (B.2) is phthalic anhydride.

The carboxylic anhydrides may be used individually or in a mixture in the process according to the invention.

Component (C):

Component (C) is low-molecular weight diols and polyols having a molecular weight of 62 to 1000 g/mol, preferably of 62 to 450 g/mol.

These include monomeric and polymeric compounds. For polymers, the molecular weight corresponds to the number-average molecular weight.

The diols and polyols to be used preferably have a functionality of 2 to 4, particularly preferably 2 to 3.

Examples include the following diols and polyols:
i) ethylene glycol, propane-1,2-diol, propane-1,3-diol, butane-1,4-diol, 2-methylpropane-1,3-diol, pentane-1,5-diol, neopentyl glycol, hexane-1,6-diol, 3-methylpentane-1,5-diol, butane-2,3-diol, diethylene glycol, triethylene glycol, tetraethylene glycol, dipropylene glycol, tripropylene glycol, and also glycerol, 1,1,1-trimethylolpropane, pentaerythritol, castor oil and oligomers of 1,4-butylene glycol.
ii) polyether polyols (especially poly(oxyalkylene) polyols):
   The polyether polyols are prepared by known methods, preferably by base-catalyzed polyaddition of alkylene oxides onto polyfunctional starter compounds having active hydrogen atoms, such as for example alcohols or amines. Examples of alcohols or amines include: ethylene glycol, diethylene glycol, 1,2-propylene glycol, butane-1,4-diol, hexamethylene glycol, bisphenol A, trimethylolpropane, glycerol, pentaerythritol, sorbitol, sucrose, degraded starch, castor oil, water, methylamine, ethylamine, propylamine, butylamine, aniline, benzylamine, o- and p-toluidine, α,β-naphthylamine, ammonia, ethylenediamine, propylenediamine, butylene-1,4-diamine, hexamethylene-1,2-, -1,3-, -1,4-, -1,5- and/or -1,6-diamine, o-, m-, and p-phenylenediamine, tolylene-2,4-, -2,6-diamine, 2,2′-, 2,4- and 4,4′-diaminodiphenylmethane and diethylenediamine.
   The alkylene oxides used are preferably ethylene oxide, propylene oxide, butylene oxide and also mixtures thereof.
   Processes for preparing such polyether polyols are described in “Kunststoffhandbuch, Band 7, Polyurethane [Plastics Handbook, volume 7, Polyurethanes]”, in “Reaction Polymers”, and also for example in U.S. Pat. Nos. 1,922,451, 2,674,619, 1,922,459, 3,190,927 and 3,346,557.
iii) polyester polyols:
   Methods for preparing polyester polyols are likewise well known and described for example in the two citations mentioned above (“Kunststoffhandbuch, Band 7, Polyurethane [Plastics Handbook, volume 7, Polyurethanes]”, “Reaction Polymers”). The polyester polyols are prepared inter alia by polycondensation of polyfunctional carboxylic acids or derivatives thereof, such as for example acid chlorides or anhydrides, with polyfunctional hydroxyl compounds.
   Examples of polyfunctional carboxylic acids that can be used include: adipic acid, phthalic acid, isophthalic acid, terephthalic acid, oxalic acid, succinic acid, glutaric acid, azelaic acid, sebacic acid, fumaric acid or maleic acid.
   Examples of the polyfunctional hydroxyl compounds that can be used include: ethylene glycol, diethylene glycol, triethylene glycol, 1,2-propylene glycol, dipropylene glycol, butane-1,3-diol, butane-1,4-diol, hexane-1,6-diol, dodecane-1,12-diol, neopentyl glycol, trimethylolpropane, triethylolpropane, castor oil or glycerol.
   The polyester polyols may in addition also be prepared by ring-opening polymerization of lactones (e.g. caprolactone) with diols and/or triols as starters.

Preference is given to using ethylene glycol, diethylene glycol, 1,2-propylene glycol, butane-1,4-diol, particular preference being given to using ethylene glycol and diethylene glycol.

The diols and polyols may be used individually or in a mixture in the process according to the invention.

Component (D):

Component (D) comprises further mono- and/or polycarboxylic acids which do not fall under the definition of components (B) and (B.2).

These include for example saturated or unsaturated, linear or branched, aliphatic or cycloaliphatic mono- and/or polycarboxylic acids or optionally branched aromatic mono- and/or polycarboxylic acids, having preferably up to 20, particularly preferably up to 10 carbon atoms (including the carbon atoms of the carboxylic acid groups), which optionally include heteroatoms from the group of oxygen (ignoring the oxygen atoms of the acid groups), sulfur, nitrogen and halogens.

The carboxylic acids (D) preferably have up to 2 acid groups.

Examples include the following mono- and polycarboxylic acids:

oxalic acid, malonic acid, succinic acid, glutaric acid, adipic acid, pimelic acid, suberic acid, azelaic acid, sebacic acid, undecanedioic acid, dodecanedioic acid, brassylic acid, tetradecanedioic acid, thapsic acid, phthalic acid, isophthalic acid, terephthalic acid, maleic acid, fumaric acid, citraconic acid, mesaconic acid, oleic acid, ricinoleic acid, furandicarboxylic acid.

The mono- and polycarboxylic acids (D) are preferably selected from the group consisting of succinic acid, glutaric acid, adipic acid, phthalic acid, terephthalic acid, oleic acid, ricinoleic acid.

The mono- and polycarboxylic acids may be used individually or in a mixture in the process according to the invention.

Component (E):

Component (E) is auxiliaries and additives which may be added to the reaction mixture as part of the first and/or second process step.

For instance, in the first process step it is possible to add compounds that catalyze the imide formation, such as for example p-toluenesulfonic acid, isoquinoline, 4-(dimethylamino)pyridine, pyridine, triethylamine, zinc acetate, acetic acid, phosphoric acid, sodium acetate, benzoic acid or sulfuric acid.

Likewise, catalysts for catalyzing the esterification reaction can be added to the reaction mixture. Examples include here: tin(II) salts, such as for example tin dichloride, tin dichloride dihydrate, tin(II) 2-ethylhexanoate, dibutyltin dilaurate; titanium alkoxides, such as for example titanium tetrabutoxide, tetraisopropyl titanate; bismuth(III) neodecanoate; zinc(II) acetate; manganese(II) acetate or protic acids, such as for example p-toluenesulfonic acid. The esterifications may furthermore also be catalyzed by enzymes, such as for example esterases and/or lipases.

Further auxiliaries and additives comprise, for example, flame retardants, surface-active additives (surfactants) such as emulsifiers and foam stabilizers, reaction retarders (e.g. acidic substances such as hydrochloric acid or organic acid halides), cell regulators (such as for example paraffins or fatty alcohols or dimethylpolysiloxanes), pigments, dyes, stabilizers against ageing and weathering effects, plasticizers, fungistatic and bacteriostatic substances, fillers (such as for example barium sulfate, kieselguhr, carbon black or whiting) and release agents.

Component (F):

Component (F) comprises, for example, diols and polyols which do not fall under the definition of component (C). These may be diols and polyols having a molecular weight of >1000 g/mol and/or polyols having functionalities>4. These are, for example, polyester polyols, polyether polyols, polyethercarbonate polyols, polyethercarbonate polyols, as are known per se for the preparation of homogeneous and of cellular polyurethanes and as described for example in EP-A 0 007 502, pages 8-15.

Bio-Based Components

In a preferred embodiment, the hydroxyl group-terminated polyesterols (A) are prepared by the process according to the invention, wherein at least one of the components (B.1), (B.2), (C), (D), (E) and (F) is bio-based.

Within the context of the present invention, bio-based means “produced from renewable raw materials”. This includes compounds that are isolated from renewable raw materials or produced therefrom. This contrasts with compounds which are produced from fossil raw materials, such as crude oil, natural gas or coal.

The compounds isolated from renewable raw materials are for example natural polyols, such as for example castor oil.

The compounds produced from renewable raw materials are for example natural amino acids, or diols or polyols, such as for example glycerol, ethylene glycol, diethylene glycol, propane-1,3-diol, butane-1,4-diol, hexane-1,6-diol, and polyols from vegetable oils, such as for example castor oil, lesquerella oil, rapeseed oil, soybean oil, and/or from unsaturated fatty acids such as for example oleic acid or ricinoleic acid. In addition, carboxylic acids produced from renewable raw materials, such as for example succinic acid, adipic acid, suberic acid, sebacic acid or azelaic acid, may be used.

Polyetherols based on renewable raw materials can be prepared for example by ring-opening polymerization of alkylene oxides using bio-based starter molecules. Examples of bio-based starter molecules that may be used also include, besides sorbitol, sugars or glycerol, hydroxyl group-containing fatty acid esters and/or hydroxyl-modified fatty acid esters, for example hydroxyl group-containing fats or oils and/or hydroxyl-modified fat derivatives such as fat-based dimer diols. Examples that can be mentioned in this connection include castor oil and lesquerella oil, both of which by nature already possess hydroxyl groups. For the remaining natural oils, such as for example soybean oil, sunflower oil, rapeseed oil or palm oil, it is necessary for a reaction with the alkylene oxides to introduce hydroxyl groups by means of chemical reactions, since these oils are generally triglycerides of saturated and unsaturated fatty acids and therefore by nature do not contain any hydroxyl groups.

The hydroxyl group-terminated polyesterols (A) obtainable according to the invention are used in the preparation of polyurethanes, preferably polyurethane foams (rigid and flexible foams). For this, they are reacted with isocyanates. The preparation of isocyanate-based foams is known per se and described for example in DE-A 1 694 142, DE-A 1 694 215 and DE-A 1 720 768 and also in Kunststoff-Handbuch [Plastics Handbook] volume VII, Polyurethane [Polyurethanes], edited by Vieweg and Höchtlein, Carl Hanser Verlag, Munich 1966, and in the new edition of this book, edited by G. Oertel, Carl Hanser Verlag Munich, Vienna 1993.

Preferably, the flexible polyurethane foams produced using the polyesterols (A) according to the invention have indices of 70 to 130, preferably 80 to 120 and apparent densities of 4 to 600 kg/m³, preferably 60 to 120 kg/m³. Preferably, the rigid polyurethane foams produced using the polyesterols (A) according to the invention have indices of 70 to 500, preferably 100 to 350 and apparent densities of 10 to 1000 kg/m³, preferably 20 to 120 kg/m³. The index (isocyanate index) indicates the percentage ratio of the isocyanate amount actually used to the stoichiometric, that is to say calculated, amount of isocyanate groups (NCO):

index=[(isocyanate amount used):(isocyanate amount calculated)]*100 (VI)

The use of the hydroxyl group-terminated polyesterols (A) according to the invention for the preparation of polyurethanes, preferably polyurethane foams is likewise provided for by the invention.

In addition, the present invention further provides the polyurethanes, preferably polyurethane foams, obtainable in this way.

The polyurethane foams obtainable according to the invention find use for example in the following: insulation panels, metal sandwich panels, refrigerator insulation, pipe insulation, expanding foam filler, furniture cushioning, textile inserts, mattresses, automobile seats, headrests, armrests, sponges, foam sheets for use in automobile parts such as for example headliners, door trim, seat covers and structural components.

In a first embodiment, the invention relates to a process for preparing hydroxyl group-terminated polyesterols (A), characterized in that
in a first process step, imide group-containing mono- or polycarboxylic acids (B) are first prepared by reacting
   (B.1) at least one amino acid having one or more amino groups and one or more acid groups with
   (B.2) at least one carboxylic anhydride having precisely one anhydride group and no further free acid groups
   in the presence of
   (C) at least one diol and/or polyol having a molecular weight of 62 to 1000 g/mol,
and, in a second process step, the reaction mixture obtained in the first process step is esterified
   without purification,
   optionally with addition of further component B.2 and/or further component C and/or (D) further mono- and/or polycarboxylic acids which do not fall under the definition of components (B) and (B.2),
under polycondensation conditions,
wherein auxiliaries and additives (E) are optionally used in the first process step and/or in the second process step and

wherein no further solvent besides component (C) is added in the first process step.

In a second embodiment, the invention relates to a process for preparing hydroxyl group-terminated polyesterols (A) according to embodiment 1, characterized in that the first process step is conducted at temperatures of 25° C. to 200° C., preferably of 80 to 180° C., and in that the second process step is conducted at temperatures of 150 to 250° C., preferably of 180 to 220° C. and at reduced pressure in the range from 0.1 to 300 mbar, preferably 1 to 200 mbar.

In a third embodiment, the invention relates to a process for preparing hydroxyl group-terminated polyesterols (A) according to embodiment 1, characterized in that the first process step is conducted at temperatures of 25° C. to 200° C., and in that the second process step is conducted at temperatures of 150 to 250° C. and at reduced pressure in the range from 0.1 to 300 mbar, preferably 1 to 200 mbar.

In a fourth embodiment, the invention relates to a process for preparing hydroxyl group-terminated polyesterols (A) according to embodiment 1, characterized in that the first process step is conducted at temperatures of 80 to 180° C., and in that the second process step is conducted at temperatures of 180 to 220° C. and at reduced pressure in the range from 0.1 to 300 mbar, preferably 1 to 200 mbar.

In a fifth embodiment, the invention relates to a process for preparing hydroxyl group-terminated polyesterols (A) according to any of embodiments 1 to 4, wherein, in the preparation of the hydroxyl group-terminated polyesterols (A), in addition to components (B.1), (B.2), (C), (D) and (E) a further component (F) is used which is diols and polyols which do not fall under the definition of component C, and wherein and the proportion of components (B.1), (B.2), (C), (D) and (E) is ≥80, preferably ≥90, particularly preferably ≥95 percent by weight of the total amount of all components used.

In a sixth embodiment, the invention relates to a process for preparing hydroxyl group-terminated polyesterols (A) according to any of embodiments 1 to 4, wherein in the preparation of the hydroxyl group-terminated polyesterols (A) exclusively the components (B.1), (B.2), (C), (D) and (E) are used.

In a seventh embodiment, the invention relates to a process for preparing hydroxyl group-terminated polyesterols (A) according to any of embodiments 1 to 6, wherein in the reaction of components (B.1) and (B.2) the molar ratio of amino groups from the amino acids (B.1) to anhydride groups from the carboxylic anhydrides (B.2) is in the range from 1.5:1 to 1:1.5, preferably 0.9:1 to 1:0.9, particularly preferably 0.95:1 to 1:0.95.

In an eighth embodiment, the invention relates to a process for preparing hydroxyl group-terminated polyesterols (A) according to any of embodiments 1 to 7, characterized in that the amino acids (B.1) are selected from the group consisting of monoaminomonocarboxylic acid, monoaminodicarboxylic acid, diaminomonocarboxylic acid and diaminodicarboxylic acid.

In a ninth embodiment, the invention relates to a process for preparing hydroxyl group-terminated polyesterols (A) according to any of embodiments 1 to 8, characterized in that the amino acids (B.1) are selected from the group consisting of anthranilic acid (o-aminobenzoic acid), m-aminobenzoic acid, p-aminobenzoic acid, alanine, arginine, asparagine, aspartic acid, cysteine, glutamine, glutamic acid, glycine, histidine, isoleucine, leucine, lysine, methionine, phenylalanine, serine, threonine, tryptophan, tyrosine, valine, ornithine, 3-aminopropionic acid, 2-aminobutyric acid, 4-aminobutyric acid, 6-aminocaproic acid, 2-amino-2-methylpropionic acid, 11-aminoundecanoic acid, homoserine.

In a tenth embodiment, the invention relates to a process for preparing hydroxyl group-terminated polyesterols (A) according to any of embodiments 1 to 9, characterized in that the carboxylic anhydrides (B.2) are selected from the group consisting of phthalic anhydride, tetrachlorophthalic anhydride, 3-chlorophthalic anhydride, maleic anhydride, citraconic anhydride, itaconic anhydride, succinic anhydride, 1,8-naphthalic anhydride, derivatives of the anhydrides mentioned, such as for example alkyl- or alkenylsuccinic acids having unbranched or branched C1 to C24 alkyl or alkenyl chains, such as (1-dodecen-1-yl) or 2-dodecen-1-yl)succinic anhydride, n-octenylsuccinic anhydride, tetradecenylsuccinic anhydride, hexadecenylsuccinic anhydride, octadecenylsuccinic anhydride, alkyl- and/or alkenylmaleic acids having unbranched or branched C1 to C24 alkyl or alkenyl chains, such as dimethylmaleic anhydride, n-dodecenylmaleic anhydride, and Diels-Alder adducts of furans and for example maleic anhydride.

In an eleventh embodiment, the invention relates to a process for preparing hydroxyl group-terminated polyesterols (A) according to any of embodiments 1 to 10, characterized in that the diols and polyols (C) are selected from the group consisting of ethylene glycol, propane-1,2-diol, propane-1,3-diol, butane-1,4-diol, 2-methylpropane-1,3-diol, pentane-1,5-diol, neopentyl glycol, hexane-1,6-diol, 3-methylpentane-1,5-diol, butane-2,3-diol, diethylene glycol, triethylene glycol, tetraethylene glycol, dipropylene glycol, tripropylene glycol, and also glycerol, 1,1,1-trimethylolpropane, pentaerythritol, castor oil, oligomers of 1,4-butylene glycol, polyether polyols such as poly(oxyalkylene) polyols and polyester polyols.

In a twelfth embodiment, the invention relates to a process for preparing hydroxyl group-terminated polyesterols (A) according to any of embodiments 1 to 11, wherein use of component D is mandatory.

In a thirteenth embodiment, the invention relates to a process for preparing hydroxyl group-terminated polyesterols (A) according to any of embodiments 1 to 12, characterized in that the mono- and/or polycarboxylic acids (D) are selected from the group consisting of oxalic acid, malonic acid, succinic acid, glutaric acid, adipic acid, pimelic acid, suberic acid, azelaic acid, sebacic acid, undecanedioic acid, dodecanedioic acid, brassylic acid, tetradecanedioic acid, thapsic acid, phthalic acid, isophthalic acid, terephthalic acid, maleic acid, fumaric acid, citraconic acid, mesaconic acid, oleic acid, ricinoleic acid and furandicarboxylic acid.

In a fourteenth embodiment, the invention relates to a process for preparing hydroxyl group-terminated polyesterols (A) according to any of embodiments 1 to 13, characterized in that the hydroxyl group-terminated polyesterols (A) have OH numbers of 20 to 500 mg KOH/g and number-average functionalities of from 1.4 to 3.5.

In a fifteenth embodiment, the invention relates to a process for preparing hydroxyl group-terminated polyesterols (A) according to any of embodiments 1 to 14, characterized in that at least one of the components (B.1), (B.2), (C), (D), (E) and (F) is bio-based.

In a sixteenth embodiment, the invention relates to hydroxyl group-terminated polyesterols (A) which are obtainable by the process as claimed in any of claims 1 to 15 and which preferably have a melting point of <23° C., particularly preferably ≤20° C.

In a seventeenth embodiment, the invention relates to hydroxyl group-terminated polyesterols (A) which are obtainable from
(B) imide group-containing mono- or polycarboxylic acids,
   which are obtainable by solvent-free reaction of
   (B.1) at least one amino acid having one or more amino groups and one or more acid groups with
   (B.2) at least one carboxylic anhydride having one or more anhydride groups,
(C) at least one diol and/or polyol having a molecular weight of 62 to 1000 g/mol,
(D) optionally further mono- and/or polycarboxylic acids which do not fall under the definition of components (B) and (B.2),
(E) optionally auxiliaries and additives
and optionally further component (B.2), and also optionally further component (C),

and preferably have a melting point of <23° C., particularly preferably ≤20° C.

In an eighteenth embodiment, the invention relates to hydroxyl group-terminated polyesterols (A) according to embodiment 16 or 17, wherein, in the preparation of the hydroxyl group-terminated polyesterols (A), in addition to components (B.1), (B.2), (C), (D) and (E) a further component (F) is used which is diols and polyols which do not fall under the definition of component C, and wherein and the proportion of components (B.1), (B.2), (C), (D) and (E) is ≥80, preferably ≥90, particularly preferably ≥95 percent by weight of the total amount of all components used.

In a nineteenth embodiment, the invention relates to hydroxyl group-terminated polyesterols (A) according to any of embodiments 16 to 18, wherein in the preparation of the hydroxyl group-terminated polyesterols (A) exclusively the components (B.1), (B.2), (C), (D) and (E) are used.

In a twentieth embodiment, the invention relates to hydroxyl group-terminated polyesterols (A) according to any of embodiments 16 to 19, wherein in the reaction of components (B.1) and (B.2) the molar ratio of amino groups from the amino acids (B.1) to anhydride groups from the carboxylic anhydrides (B.2) is in the range from 1.5:1 to 1:1.5, preferably 0.9:1 to 1:0.9, particularly preferably 0.95:1 to 1:0.95.

In a twenty-first embodiment, the invention relates to hydroxyl group-terminated polyesterols (A) according to any of embodiments 16 to 20, characterized in that the amino acids (B.1) are selected from the group consisting of monoaminomonocarboxylic acid, monoaminodicarboxylic acid, diaminomonocarboxylic acid and diaminodicarboxylic acid.

In a twenty-second embodiment, the invention relates to hydroxyl group-terminated polyesterols (A) according to any of embodiments 16 to 21, characterized in that the amino acids (B.1) are selected from the group consisting of anthranilic acid (o-aminobenzoic acid), m-aminobenzoic acid, p-aminobenzoic acid, alanine, arginine, asparagine, aspartic acid, cysteine, glutamine, glutamic acid, glycine, histidine, isoleucine, leucine, lysine, methionine, phenylalanine, serine, threonine, tryptophan, tyrosine, valine, ornithine, 3-aminopropionic acid, 2-aminobutyric acid, 4-aminobutyric acid, 6-aminocaproic acid, 2-amino-2-methylpropionic acid, 11-aminoundecanoic acid, homoserine.

In a twenty-third embodiment, the invention relates to hydroxyl group-terminated polyesterols (A) according to any of embodiments 16 to 22, characterized in that the carboxylic anhydrides (B.2) are selected from the group consisting of phthalic anhydride, tetrachlorophthalic anhydride, 3-chlorophthalic anhydride, maleic anhydride, citraconic anhydride, itaconic anhydride, succinic anhydride, 1,8-naphthalic anhydride, derivatives of the anhydrides mentioned, such as for example alkyl- or alkenylsuccinic acids having unbranched or branched C1 to C24 alkyl or alkenyl chains, such as (1-dodecen-1-yl) or 2-dodecen-1-yl)succinic anhydride, n-octenylsuccinic anhydride, tetradecenylsuccinic anhydride, hexadecenylsuccinic anhydride, octadecenylsuccinic anhydride, alkyl- and/or alkenylmaleic acids having unbranched or branched C1 to C24 alkyl or alkenyl chains, such as dimethylmaleic anhydride, n-dodecenylmaleic anhydride, and Diels-Alder adducts of furans and for example maleic anhydride.

In a twenty-fourth embodiment, the invention relates to hydroxyl group-terminated polyesterols (A) according to any of embodiments 16 to 23, characterized in that the diols and polyols (C) are selected from the group consisting of ethylene glycol, propane-1,2-diol, propane-1,3-diol, butane-1,4-diol, 2-methylpropane-1,3-diol, pentane-1,5-diol, neopentyl glycol, hexane-1,6-diol, 3-methylpentane-1,5-diol, butane-2,3-diol, diethylene glycol, triethylene glycol, tetraethylene glycol, dipropylene glycol, tripropylene glycol, and also glycerol, 1,1,1-trimethylolpropane, pentaerythritol, castor oil, oligomers of 1,4-butylene glycol, polyether polyols such as poly(oxyalkylene) polyols and polyester polyols.

In a twenty-fifth embodiment, the invention relates to hydroxyl group-terminated polyesterols (A) according to any of embodiments 16 to 24, wherein use of component (D) is mandatory.

In a twenty-sixth embodiment, the invention relates to hydroxyl group-terminated polyesterols (A) according to any of embodiments 16 to 25, characterized in that the mono- and/or polycarboxylic acids (D) are selected from the group consisting of oxalic acid, malonic acid, succinic acid, glutaric acid, adipic acid, pimelic acid, suberic acid, azelaic acid, sebacic acid, undecanedioic acid, dodecanedioic acid, brassylic acid, tetradecanedioic acid, thapsic acid, phthalic acid, isophthalic acid, terephthalic acid, maleic acid, fumaric acid, citraconic acid, mesaconic acid, oleic acid, ricinoleic acid and furandicarboxylic acid.

In a twenty-seventh embodiment, the invention relates to hydroxyl group-terminated polyesterols (A) according to any of embodiments 16 to 26, characterized in that the hydroxyl group-terminated polyesterols (A) have OH numbers of 20 to 500 mg KOH/g and number-average functionalities of from 1.4 to 3.5.

In a twenty-eighth embodiment, the invention relates to hydroxyl group-terminated polyesterols (A) according to any of embodiments 16 to 27, characterized in that at least one of the components (B.1), (B.2), (C), (D), (E) and (F) is bio-based.

In a twenty-ninth embodiment, the invention relates to the use of the hydroxyl group-terminated polyesterols (A) as claimed in any of claims 16 to 28 for the preparation of polyurethanes, preferably polyurethane foams.

### EXAMPLES

1. Methods and Materials

1.1 Raw Materials Used:

| | |
|---|---|
| Trimellitic anhydride | (Fluka) |
| Anthranilic acid | (Sigma-Aldrich) |
| Acetic acid | (Fisher Scientific) |
| Glutaric acid, technical grade | (Lanxess AG) |
| Adipic acid | (BASF) |
| Phthalic anhydride | (My-ChemGmbH) |
| Diethylene glycol | (Sigma-Aldrich) |
| Ethylene glycol (Ineos) | |
| DL-Glutamic acid | (Sigma-Aldrich) |
| DL-Aspartic acid | (abcr) |
| DL-Lysine | (Sigma-Aldrich) |
| SnCl₂•2H₂O | (Sigma-Aldrich) |
| Glycerol | (Sigma-Aldrich) |
| 3-Amino-1-propanol | (Acros-Organics) |
| Diglycol terephthalate | (Sigma-Aldrich) |
| L 2830: | Desmophen ® L 2830 (Covestro AG), |
| | aliphatic polyether polyol having OH |
| | number of 28 mg KOH/g, a molar mass |
| | of 4000 Da and approx. 90 |
| | mol % of primary OH end groups and |
| | a viscosity of 860 mPas at 25° C. |
| TCPP | Levagard PP ® (Lanxess AG), |
| | trischloroisopropyl phosphate |
| B 8433 | Tegostab ® B844 (Evonik Industries |
| | AG), silicone stabilizer |
| B 8325 | Tegostab ® B8325 (Evonik Industries |
| | AG), silicone stabilizer |
| DB | Desmorapid ® DB (Covestro AG), |
| | activator for the production of |
| | rigid polyurethane foams |
| 1792 | Desmorapid ® 1792 (Covestro AG), |
| | preparation containing |
| | diethylene glycol and potassium |
| | acetate; trimerization catalyst |
| A30 | Niax* Catalyst A-30 (Momentive |
| | Performance Materials Inc.), |
| | tertiary amine. Catalyst for the |
| | water reaction |
| 117 | Addocat ® 117 (Lanxess AG), tertiary |
| | amine Catalyst for the urethane reaction |
| Water | deionized water |
| n-pentane | (Azelis) |
| 44V70L | Desmodur ® 44V70 L (Covestro AG), |
| | MDI isocyanate having an |
| | NCO content of 30% to 32% by weight |
| T80 | Desmodur ® T80 (Covestro AG), TDI |
| | isocyanate having an NCO |
| | content of at least 48% by weight |
| T65N | Desmodur ® T65N (Covestro AG), |
| | TDI isocyanate having an NCO |
| | content of at least 48% by weight |

1.2 Methods Used

The analyses were conducted as follows:

Viscosity:

MCR 51 rheometer from Anton Paar in accordance with DIN 53019 using a CP 50-1 measuring cone, diameter 50 mm, angle 1° at shear rates of 25, 100, 200 and 500 s⁻¹. The inventive and non-inventive polyester polyols exhibit viscosity values that are independent of the shear rate.
Hydroxyl number: determined according to DIN 53240-1 (method without catalyst, June 2013).
Acid number: determined according to DIN 51639-1 (November 2014).
Amine number: determined according to DIN EN ISO 2114 (June 2002).
Apparent density: determined according to DIN EN ISO 845 (October 2009).
Flammability characteristics: determined for rigid foams according to DIN 4102-1 (May 1998). determined for flexible foams according to DIN 75200 (September 1980).
Compressive strength rigid foam: compressive stress determined at 10% compression according to DIN EN ISO 844 (November 2014).
Compressive strength flexible foam: compressive stress determined at 40% compression according to DIN EN ISO 3386-1 (October 2015).
Open-cell content: determined according to DIN EN ISO 4590 (December 2016, method 1) with AccuPyc 1330.
Dimensional stability: determined according to DIN ISO 2796 (January 1986)
Melting point: It is determined whether the melting point of the polyesterols is below room temperature. To this end, the polyesterol is stored at room temperature (23° C.) for at least 4 weeks after preparation and inspected visually to determine whether the polyol remains homogeneous and in the liquid state of matter. Polyesterols that crystallize, form solids or become cloudy during this storage are discarded.

2. Polyester Synthesis

2.1 One-Pot Synthesis Trimellitic Anhydride/Ethylene Glycol/Glycerol/Aminopropanol/Diglycol Terephthalate (Non-Inventive, Comparative Example According to FR1445078A)

A 2 l four-neck round-bottomed flask equipped with mechanical stirrer, heating mantle, bottom thermometer, nitrogen gas connection, diaphragm pump vacuum connection and a 40 cm filler column with attached column head and jacketed coil condenser was initially charged with 300 g of ethylene glycol (4.83 mol), 46 g of glycerol (0.50 ml), 75 g of 3-amino-1-propanol (1.00 mol) while passing nitrogen through. The mixture was heated to 50° C. and 192 g of trimellitic anhydride (1.00 mol) were added. The mixture was heated to 140° C. for 80 min in order to convert amine and anhydride to the imide. The reaction mixture was cooled to 120° C. and 127 g of diglycol terephthalate (1.00 mol) and the catalyst (14 mg of SnCl₂.2H₂O) were added. The reaction mixture was heated to a bottom temperature of 200° C. and the pressure was lowered in steps over 6 h to approx. 100 mbar, in the course of which 298 g of distillate was collected. The mixture was stirred at a bottom temperature of 220° C. and 60 mbar of pressure for a further 4 h, in the course of which a further 30 g of distillate was collected.

The product obtained was so highly viscous at room temperature (>100 000 mPa*s at 25° C.) that further processing and use for the production of polyurethane foams was impossible.

2.2 One-Pot Synthesis Anthranilic Acid/Trimellitic Anhydride/Glutaric Acid (Non-Inventive)

A 2 l four-neck round-bottomed flask equipped with mechanical stirrer, heating mantle, bottom thermometer, nitrogen gas connection, diaphragm pump vacuum connection and a 40 cm filler column with attached column head and jacketed coil condenser was initially charged with 349 g of diethylene glycol (3.29 mol) while passing nitrogen through. To this were added 192 g of trimellitic anhydride (1.00 mol) and 137 g of anthranilic acid (1.00 mol) and the reaction mixture was stirred at a bottom temperature of 150° C. for 4 hours. Technical-grade glutaric acid (134 g, 1.00 mol) was added and the reaction mixture was heated to a bottom temperature of 200° C. over 2 hours, in the course of which water was distilled off. 15 mg of SnCl₂.2H₂O were added and the mixture was stirred under reduced pressure at a bottom temperature of 210° C. for 43 hours. 45 g of diethylene glycol (0.42 mol) were added and the mixture was stirred under reduced pressure at a bottom temperature of 200° C. for a further 5 hours. After cooling, the following properties of the polyester were determined:
Hydroxyl number (mg KOH/g): 198
Acid number (mg KOH/g): 1.2
Viscosity (mPa*s at 25° C.): n.d./>50 000
Viscosity (mPa*s at 50° C.): 4050

2.3 One-Pot Synthesis Anthranilic Acid/Phthalic Anhydride/Adipic Acid (Inventive Process)

A 4 l four-neck round-bottomed flask equipped with mechanical stirrer, heating mantle, bottom thermometer, nitrogen gas connection, diaphragm pump vacuum connection and a 40 cm filler column with attached column head and jacketed coil condenser was initially charged with 849 g of diethylene glycol (8.00 mol) while passing nitrogen through. To this were added 296 g of phthalic anhydride (2.00 mol) and 274 g of anthranilic acid (2.00 mol) and the reaction mixture was stirred at a bottom temperature of 150° C. for 3 hours. After cooling to a bottom temperature of 110° C., adipic acid (587 g, 4.02 mol) was added and the reaction mixture was heated to a bottom temperature of 200° C. over 2 hours, in the course of which water was distilled off. 36 mg of SnCl₂.2H₂O were added and the mixture was stirred under reduced pressure at a bottom temperature of 200 to 210° C. for 66 hours. After cooling, the following properties of the polyester were determined:
Hydroxyl number (mg KOH/g): 177
Acid number (mg KOH/g): 2.0
Viscosity (mPa*s at 25° C.): 2330

2.4 One-Pot Synthesis Aspartic Acid/Phthalic Anhydride/Adipic Acid (Inventive)

A 2 l four-neck round-bottomed flask equipped with mechanical stirrer, heating mantle, bottom thermometer, nitrogen gas connection, diaphragm pump vacuum connection and a 40 cm filler column with attached column head and jacketed coil condenser was initially charged with 497 g of diethylene glycol (4.68 mol) while passing nitrogen through. To this were added 148 g of phthalic anhydride (1.00 mol) and 133 g of aspartic acid (1.00 mol) and the reaction mixture was stirred at a bottom temperature of 150° C. for 4.5 hours. After cooling to a bottom temperature of 120° C., adipic acid (292 g, 2.00 mol) was added and the reaction mixture was heated to a bottom temperature of 200° C. over 1.5 hours, in the course of which water was distilled off. 19 mg of SnCl₂.2H₂O were added and the mixture was stirred under reduced pressure at a bottom temperature of 200° C. for 19 hours. After cooling, the following properties of the polyester were determined:
Hydroxyl number (mg KOH/g): 180
Acid number (mg KOH/g): 2.0
Viscosity (mPa*s at 25° C.): 4600

2.5 One-Pot Synthesis Glutamic Acid/Phthalic Anhydride/Adipic Acid (Inventive Process)

A 2 l four-neck round-bottomed flask equipped with mechanical stirrer, heating mantle, bottom thermometer, nitrogen gas connection, diaphragm pump vacuum connection and a 40 cm filler column with attached column head and jacketed coil condenser was initially charged with 500 g of diethylene glycol (4.71 mol) while passing nitrogen through. To this were added 148 g of phthalic anhydride (1.00 mol) and 147 g of glutamic acid (1.00 mol) and the reaction mixture was stirred at a bottom temperature of 150° C. for 2.5 hours. After cooling to a bottom temperature of 120° C., adipic acid (292 g, 2.00 mol) was added and the reaction mixture was heated to a bottom temperature of 200° C. over 2 hours, in the course of which water was distilled off. 19 mg of SnCl₂.2H₂O were added and the mixture was stirred under reduced pressure at a bottom temperature of 200° C. for 25 hours. 47 g of diethylene glycol (0.44 mol) were added and the mixture was stirred under reduced pressure at a bottom temperature of 200° C. for a further 15 hours. After cooling, the following properties of the polyester were determined:
Hydroxyl number (mg KOH/g): 202
Acid number (mg KOH/g): 0.8
Viscosity (mPa*s at 25° C.): 2350

2.6 One-Pot Synthesis Glutamic Acid/Phthalic Anhydride (Inventive Process)

A 2 l four-neck round-bottomed flask equipped with mechanical stirrer, heating mantle, bottom thermometer, nitrogen gas connection, diaphragm pump vacuum connection and a 40 cm filler column with attached column head and jacketed coil condenser was initially charged with 502 g of diethylene glycol (4.73 mol) while passing nitrogen through. To this were added 305 g of phthalic anhydride (2.06 mol) and 304 g of glutamic acid (2.07 mol) and the reaction mixture was stirred at a bottom temperature of 150° C. for 2.5 hours. The reaction mixture was heated to a bottom temperature of 210° C. over 2 hours, in the course of which water was distilled off. 20 mg of SnCl₂.2H₂O were added and the mixture was stirred under reduced pressure at a bottom temperature of 180-210° C. for 2 hours. 98 g of diethylene glycol (0.92 mol) were added and the mixture was stirred under reduced pressure at a bottom temperature of 200-210° C. for a further 11 hours. After cooling, the following properties of the polyester were determined:
Hydroxyl number (mg KOH/g): 297
Acid number (mg KOH/g): 0.8
Viscosity (mPa*s at 25° C.): 6500

2.7 One-Pot Synthesis Lysine/Phthalic Anhydride/Glutaric Acid (Inventive Process)

A 2 l four-neck round-bottomed flask equipped with mechanical stirrer, heating mantle, bottom thermometer, nitrogen gas connection, diaphragm pump vacuum connection and a 40 cm filler column with attached column head and jacketed coil condenser was initially charged with 400 g of diethylene glycol (3.77 mol) while passing nitrogen through. To this were added 355 g of phthalic anhydride (2.40 mol) and 176 g of lysine (1.20 mol) and the reaction mixture was stirred at a bottom temperature of 150° C. for 2.5 hours. Technical-grade glutaric acid (178 g, 1.33 mol) was added and the reaction mixture was heated to a bottom temperature of 200° C. over 2 hours, in the course of which water was distilled off. 20 mg of SnCl₂.2H₂O were added and the mixture was stirred under reduced pressure at a bottom temperature of 200° C. for 16 hours. After cooling, the following properties of the polyester were determined:
Hydroxyl number (mg KOH/g): 182
Acid number (mg KOH/g): 0.5
Viscosity (mPa*s at 25° C.): 17000

3. Rigid Polyurethane Foams

Rigid polyurethane foams were produced from the above-described polyesterols having an OH number of 150 to 250 according to the following general method. All parts are parts by weight:

| | |
|---|---|
| L2830 | 12 parts |
| Polyester (OH number 150-250) | 73 parts |
| TCPP | 15 parts |
| B 8443 | 3 parts |
| Water | 0.8 parts |
| DB | 1.7 parts |
| 1792 | 2.8 parts |
| n-Pentane | approx. 13.4 |
| | parts |
| 44V70L | approx. 200 |
| | parts |

The exact amount of n-pentane is calculated according to the desired apparent density of the foam. The exact amount of the isocyanate V70L is calculated so that an index (100*molar ratio of NCO groups to NCO-reactive groups) of 350 is achieved.

The polyols, stabilizers, water, flame retardants and catalysts are stirred for 60 s using a Pendraulik stirrer at 1000 rpm. n-Pentane is added and the mixture is homogenized at 500-1000 rpm. The isocyanate is added and the mixture is stirred for 10 s at 4200 rpm. The mixture is poured into a paper mold and allowed to react to completion. After storage at room temperature overnight, the rigid foam is sawed up and analyzed.

The comparison standard polyester was prepared from glutaric acid and ethylene glycol (OH number 216, viscosity at 25° C. 1980 mPas).

| Polyester | Standard | 2.3 | 2.4 | 2.5 | 2.6 | 2.7 |
|---|---|---|---|---|---|---|
| Apparent density | 40 | 41 | 41 | 41 | 42 | 42 |
| [g/l] | | | | | | |
| Fire test [cm] | 10 | 12 | 13 | 11 | 12 | 10 |
| Compressive stress | 345; 153 | 364; 164 | 378; 155 | 402; 151 | 424; 169 | 356; 220 |
| at 10% compression, | | | | | | |
| parallel; transverse | | | | | | |
| [kPa] | | | | | | |
| Open-cell content | 9.3 | 6.7 | 6.6 | 7.8 | 8 | 7.3 |
| [%] | | | | | | |
| Dimensional | 0.1; 0.3; 0.2 | 0.2; 0.2; 0.1 | 0.8; 0.0; 0.1 | 0.8; 0.1; 0.1 | 0.2; 0.4; 0.5 | 0.3; 0.4; 0.3 |
| stability −22° C. [%] | | | | | | |
| Dimensional | 0.5; 0.4; 0.7 | 0.7; 0.3; 0.3 | 1.1; 0.5; 0.6 | 0.6; 0.4; 0.4 | 1.2; 0.5; 0.1 | 0.3; 0.3; 0.5 |
| stability 100° C. [%] | | | | | | |

1. A process for preparing a hydroxyl group-terminated polyesterol (A) comprising:
in a first process step, preparing an imide group-containing mono- or polycarboxylic acid (B) by reacting
(B.1) at least one amino acid having one or more amino groups and one or more acid groups with
(B.2) at least one carboxylic anhydride having precisely one anhydride group and no further free acid groups
in the presence of
(C) at least one diol and/or polyol having a molecular weight of 62 to 1000 g/mol,
and, in a second process step, esterifying the reaction mixture obtained in the first process
without purification,
optionally with addition of further component B.2 and/or further component C and/or (D) at least one further mono- and/or polycarboxylic acid which does not fall under the definition of components (B) and (B.2),
under polycondensation conditions,
wherein auxiliaries and additives (E) are optionally used in the first process step and/or in the second process step and
wherein no further solvent besides component (C) is added in the first process step.

2. The process for preparing a hydroxyl group-terminated polyesterol (A) of claim 1, wherein the first process step is conducted at a temperature of 25° C. to 200° C. and the second process step is conducted at a temperature of 150 to 250° C. and at a reduced pressure of 0.1 to 300 mbar.

3. A hydroxyl group-terminated polyesterol obtained by the process as claimed in claim 1.

4. The process as claimed in claim 1, wherein, in the preparation of the hydroxyl group-terminated polyesterol (A), in addition to components (B.1), (B.2), (C), (D) and (E) a further component (F) is used which comprises diols and polyols which do not fall under the definition of component (C), and wherein the proportion of components (B.1), (B.2), (C), (D) and (E) is ≥80 percent by weight, based on the total amount of all components used.

5. The process as claimed in claim 1, wherein in the preparation of the hydroxyl group-terminated polyesterol (A) exclusively the components (B.1), (B.2), (C), (D) and (E) are used.

6. The process as claimed in claim 1, wherein in the reaction of components (B.1) and (B.2), the molar ratio of amino groups from the at least one amino acid (B.1) to anhydride groups from the at least one carboxylic anhydride (B.2) is in the range from 1.5:1 to 1:1.5.

7. The process as claimed in claim 1, wherein the at least one amino acid (B.1) comprises monoaminomonocarboxylic acid, monoaminodicarboxylic acid, diaminomonocarboxylic acid or diaminodicarboxylic acid.

8. The process as claimed in claim 1, wherein the at least one amino acid (B.1) comprises anthranilic acid (o-aminobenzoic acid), m-aminobenzoic acid, p-aminobenzoic acid, alanine, arginine, asparagine, aspartic acid, cysteine, glutamine, glutamic acid, glycine, histidine, isoleucine, leucine, lysine, methionine, phenylalanine, serine, threonine, tryptophan, tyrosine, valine, ornithine, 3-aminopropionic acid, 2-aminobutyric acid, 4-aminobutyric acid, 6-aminocaproic acid, 2-amino-2-methylpropionic acid, 11-aminoundecanoic acid, or homoserine.

9. The process as claimed in claim 1, wherein the at least one carboxylic anhydride (B.2) comprises phthalic anhydride, tetrachlorophthalic anhydride, 3-chlorophthalic anhydride, maleic anhydride, citraconic anhydride, itaconic anhydride, succinic anhydride, 1,8-naphthalic anhydride, or a derivative of any of the foregoing anhydrides.

10. The process as claimed in claim 1, wherein component (C) comprises ethylene glycol, propane-1,2-diol, propane-1,3-diol, butane-1,4-diol, 2-methylpropane-1,3-diol, pentane-1,5-diol, neopentyl glycol, hexane-1,6-diol, 3-methylpentane-1,5-diol, butane-2,3-diol, diethylene glycol, triethylene glycol, tetraethylene glycol, dipropylene glycol, tripropylene glycol, glycerol, 1,1,1-trimethylolpropane, pentaerythritol, castor oil, an oligomer of 1,4-butylene glycol, or a polyether polyol.

11. The process as claimed in claim 1, wherein the at least one mono- and/or polycarboxylic acid (D) comprises oxalic acid, malonic acid, succinic acid, glutaric acid, adipic acid, pimelic acid, suberic acid, azelaic acid, sebacic acid, undecanedioic acid, dodecanedioic acid, brassylic acid, tetradecanedioic acid, thapsic acid, phthalic acid, isophthalic acid, terephthalic acid, maleic acid, fumaric acid, citraconic acid, mesaconic acid, oleic acid, ricinoleic acid or furandicarboxylic acid.

12. The process as claimed in claim 1, wherein the hydroxyl group-terminated polyesterol (A) has an OH number of 20 to 500 mg KOH/g and a number-average functionality of 1.4 to 3.5.

13. The process as claimed in claim 1, wherein at least one of the components (B.1), (B.2), (C), (D), (E) and (F) is bio-based.

14. A polyurethane prepared from the hydroxyl group-terminated polyesterol (A) as claimed in claim 3.

15. The hydroxyl group-terminated polyesterol of claim 3, wherein the hydroxyl group-terminated polyesterol has a melting point of <23° C.

16. The hydroxyl group-terminated polyesterol of claim 15, wherein the hydroxyl group-terminated polyesterol has a melting point of ≤20° C.

17. The polyurethane of claim 14, wherein the polyurethane is a polyurethane foam.
